(19) United States
(12) Patent Application Publication
(10) Pub. No.: US 2018/0107546 A1
(43) Pub. Date: Apr. 19, 2018

(54) DATA STORAGE SYSTEM WITH VIRTUAL BLOCKS AND RAID AND MANAGEMENT METHOD THEREOF

(71) Applicant: PROMISE TECHNOLOGY, INC, Hsin-Chu (TW)

(72) Inventors: CHENG-YI HUANG, Hsin-Chu (TW); SHIN-PING LIN, Hsin-Chu (TW); YUN-MIN CHENG, Hsin-Chu (TW)

(21) Appl. No.: 15/683,378

(22) Filed: Aug. 22, 2017

(30) Foreign Application Priority Data
Oct. 14, 2016 (TW) 105133252

(51) Int. Cl. G06F 11/10; G06F 3/06; G06F 12/10

(52) U.S. Cl. CPC G06F 11/1092; G06F 3/0689; G06F 3/0619; G06F 3/0665; G06F 2212/657; G06F 12/10; G06F 2212/1032; G06F 2212/152; G06F 3/064

(57) ABSTRACT

The invention discloses a data storage system and managing method thereof. The data storage system according to the invention accesses or rebuilds data based on a plurality of primary logical storage devices and at least one spare logical storage device. The primary logical storage devices are planned into a plurality of data blocks in a first RAID architecture. The at least one spare logical storage device is planned into a plurality of spare blocks in a second RAID architecture. The data storage system according to the invention utilizes a plurality of virtual storage devices and several one-to-one and onto functions to distributedly map the data blocks and the spare blocks to a plurality of blocks in a plurality of physical storage devices.

### CROSS-REFERENCE TO RELATED APPLICATION

This utility application claims priority to Taiwan Application Serial Number 105133252, filed Oct. 14, 2016, which is incorporated herein by reference.

### BACKGROUND OF THE INVENTION

### 1. Field of the invention

The invention relates to a data storage system and a managing method thereof, and in particular, to a data storage system with virtual blocks and RAID (Redundant Array of Independent Drives) architectures and a managing method thereof to significantly reduce time spent in reconstructing failed or replaced storage devices in the data storage system.

### 2. Description of the prior art

With more and more amount of user data stored as demanded, Redundant Array of Independent Drives (RAID) systems have been widely used to store a large amount of digital data. RAID systems are able to provide high availability, high performance, or high volume of data storage volume for hosts.

Constitution of the well-known RAID system includes a RAID controller and a RAID composed of a plurality of physical storage devices. The RAID controller is coupled to each physical storage device, and defines the physical storage devices as one or more logical disk drives selected among RAID 0, RAID 1, RAID 2, RAID 3, RAID 4, RAID 5, RAID 6, and others. The RAID controller can also generate (re-construct) redundant data which are identical to data to be read.

In one embodiment, each of the physical storage devices can be a tape drive, a disk drive, a memory device, an optical storage drive, a sector corresponding to a single read-write head in the same disk drive, or other equivalent storage device.

By different redundancy/data storage way utilized in different RAID level, the RAID system can be implemented at different RAID level. For example, the RAID system of RAID 1 utilizes a disk mirroring where a first storage device conserves stored data, and a second storage device conserves the data exactly duplicated from the data stored in the first storage device. If any of the storage devices is damaged, the data in the remaining storage device is still available, so no data are lost.

In the RAID systems of other RAID levels, each physical storage device is divided into a plurality of data blocks. On the viewpoint of fault tolerance, the plurality of data blocks can be classified into two kinds of data blocks which are the user data blocks and the parity data blocks. The user data blocks store general user data. The parity data blocks store the remaining parity data to provide to inversely calculate the user data when the fault tolerant is required. The corresponding user data blocks and the parity data block in different data storage devices form a stripe, where data in the parity data block are a result of Exclusive OR (XOR) operation executed on the data in the user data blocks. If any of the physical storage devices in these RAID systems is damaged, the user data and the parity data stored in the undamaged physical storage devices can be used to execute the XOR operation to reconstruct the data stored in the damaged physical storage device. It is noticed that those of ordinary skill in the art all understand the calculation of the data in the parity data blocks can also be executed by, other than Exclusive or (XOR) operation, various parity operations or similar operations which just have the relationship that data of any data block can be obtained by calculating data of corresponding data blocks in the same stripe.

In general, the reconstruction of one of the physical storage devices in an RAID system is performed by reading in sequence the logical block addresses of the non-replaced physical storage devices, calculating the data of the corresponding logical block addresses of the damaged physical storage device, and then writing the calculated data in the logical block addresses of the replaced physical storage device. The above procedures perform until all of the logical block addresses of the non-replaced physical storage devices are read. Obviously, with more and more capacity of physical storage devices (currently available physical storage device in the market has more than 4TB capacity), reconstruction of the physical storage device in a conventional way will take much time or even more than 600 minutes.

There has been a prior art using virtual storage devices to reduce the time spent in reconstructing the damaged physical storage device. As for the prior art of virtual storage devices, please refer to U.S. Pat. No. 8,046,537. U.S. Pat. No. 8,046,537 creates a mapping table recording the mapping relationship between the blocks in the virtual storage devices and the blocks in the physical storage devices. However, as the capacity of the physical storage device increases, the above mapping table also increases its memory space.

There has been another prior art that does not concentrate the blocks originally belonging to the same storage stripe, but rather dispersedly map these blocks to of the physical storage devices to reduce the time spent in reconstructing the damaged physical storage device. As for the prior art mentioned above, please refer to Chinese Patent Publication No. 101923496. However, Chinese Patent Publication No. 101923496 still utilizes at least one spare physical storage device, so that the procedure for rewriting the data into the at least one spare physical storage device during the reconstruction of the damaged physical storage device is a significant bottleneck.

At present, as for the prior arts, there is still much room for improvement in significantly reducing of time spent to reconstruct the damaged physical storage device of the data storage system.

### SUMMARY OF THE INVENTION

Accordingly, one scope of the invention is to a data storage system and a managing method thereof, special for the data storage system specifying in a RAID architecture. Moreover, in particular, the data storage system and the managing method thereof according to the invention have virtual blocks and RAID architectures, and can significantly reduce time spent in reconstructing failed or replaced storage devices in the data storage system.

A data storage system according to a preferred embodiment of the invention includes a disk array processing module, a plurality of physical storage devices and a virtual block processing module. The disk array processing module functions in accessing or rebuilding data on the basis of a plurality of primary logical storage devices and at least one spare logical storage device. The plurality of primary logical storage devices are planned into a plurality of data blocks in a first RAID architecture. The at least one spare logical storage device is planned into a plurality of spare blocks in a second RAID architecture. Each data block and each spare block are considered as a chunk and are assigned a unique chunk identifier (Chunk_ID) in sequence, and a chunk size (Chunk_Size) of each chunk is defined. The plurality of physical storage devices are grouped into at least one storage pool. Each physical storage device is assigned a unique physical storage device identifier (PD_ID), and planned into a plurality of first blocks. The size of each first block is equal to the Chunk_Size. A respective physical storage device count (PD_Count) of each storage pool is defined. The virtual block processing module is respectively coupled to the disk array processing module and the plurality of physical storage devices. The virtual block processing module functions in building a plurality of virtual storage devices. Each virtual storage device is assigned a unique virtual storage device identifier (VD_ID), and planned into a plurality of second blocks. The size of each second block is equal to the Chunk_Size. A virtual storage device count (VD_Count) of the plurality of virtual storage devices is defined. The virtual block processing module calculates one of the Chunk_IDs mapping each second block in accordance with the Chunk_Size, the VD_Count, the VD_ID and a virtual storage device logical block address (VD_LBA) in the virtual storage devices, and calculates the PD_ID of one of the first blocks and a physical storage device logical block address (PD_LBA) in the physical storage devices mapping said one Chunk_ID. The disk array processing module accesses data in accordance with the PD_ID and the PD_LBA of each Chunk_ID.

A managing method, according to a preferred embodiment of the invention, is performed for a data storage system. The data storage system accesses or rebuilds data on the basis of a plurality of primary logical storage devices and at least one spare logical storage device. The plurality of primary logical storage devices are planned into a plurality of data blocks in a first RAID architecture. The at least one spare logical storage device is planned into a plurality of spare blocks in a second RAID architecture. Each data block and each spare block are considered as a chunk and are assigned a unique chunk identifier (Chunk_ID) in sequence. A chunk size (Chunk_Size) of the chunk is defined. The data storage system includes a plurality of physical storage devices. Each physical storage device is assigned a unique physical storage device identifier (PD_ID), and planned into a plurality of first blocks. The size of each first block is equal to the Chunk_Size. The managing method of the invention is, firstly, to group the plurality of physical storage devices into at least one storage pool where a respective physical storage device count (PD_Count) of each storage pool is defined. Next, the managing method of the invention is to build a plurality of virtual storage devices. Each virtual storage device is assigned a unique virtual storage device identifier (VD_ID), and planned into a plurality of second blocks. The size of each second block is equal to the Chunk_Size. A virtual storage device count (VD_Count) of the plurality of virtual storage devices is defined. Afterward, the managing method of the invention is to calculate one of the Chunk_IDs mapping each second block in accordance with the Chunk_Size, the VD_Count, the VD_ID and a virtual storage device logical block address (VD_LBA) in the virtual storage devices. Then, the managing method of the invention is to calculate the PD_ID of one of the first blocks and a physical storage device logical block address (PD_LBA) in the physical storage devices mapping said one Chunk_ID. Finally, the managing method according the invention is to access data in accordance with the PD_ID and the PD_LBA of each Chunk_ID.

In one embodiment, the calculation of one of the Chunk_IDs mapping each second block is executed by a first one-to-one and onto function.

In one embodiment, the calculation of the PD_ID of one of the first blocks mapping said one Chunk_ID is executed by a second one-to-one and onto function. The calculation of the PD LBA in the physical storage devices mapping said one Chunk₁₃ ID is executed by a third one-to-one and onto function.

Compared to the prior arts, the data storage system and the managing method thereof according to the invention have no spare physical storage device, have virtual blocks and RAID architectures, and can significantly reduce time spent in reconstructing failed or replaced storage devices in the data storage system.

The advantage and spirit of the invention may be understood by the following recitations together with the appended drawings.

### BRIEF DESCRIPTION OF THE APPENDED DRAWINGS

FIG. 1 is a schematic diagram showing the architecture of a data storage system according to a preferred embodiment of the invention.

FIG. 2 is a schematic diagram showing an example of a mapping relationship between a plurality of data blocks of a first RAID architecture and a plurality of second blocks of a plurality of virtual storage devices.

FIG. 3 is a schematic diagram showing an example of a mapping relationship between a plurality of data blocks of a first RAID architecture and a plurality of first blocks of a plurality of physical storage devices of a storage pool.

FIG. 4 is a schematic diagram showing an example of mapping the user data blocks, the parity data blocks and the spare blocks in the same block group to the plurality of first blocks of the plurality of physical storage devices.

FIG. 5 is a flow diagram illustrating a managing method according to a preferred embodiment of the invention.

### DETAILED DESCRIPTION OF THE INVENTION

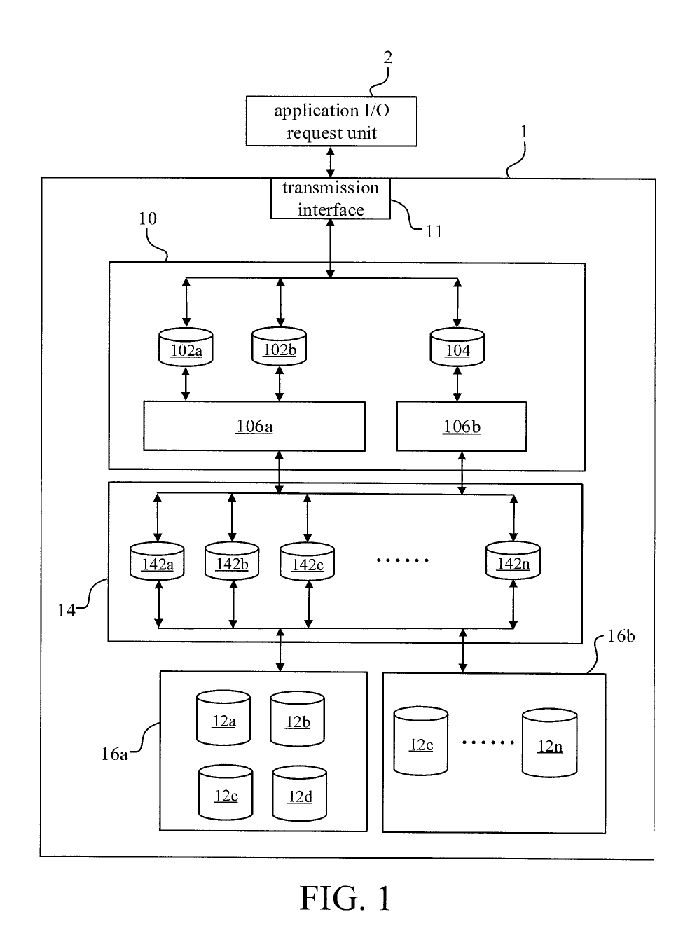

Referring to FIG. 1, the architecture of a data storage system 1 according to a preferred embodiment of the invention is illustratively shown in FIG. 1.

As shown in FIG. 1, the data storage system 1 of the invention includes a disk array processing module 10, a plurality of physical storage devices (12a˜12n) and a virtual block processing module 14.

The disk array processing module 10 functions in accessing or rebuilding data on the basis of a plurality of primary logical storage devices (102a, 102b) and at least one spare logical storage device 104. It is noted that the plurality of primary logical storage devices (102a, 102b) and the at least one spare logical storage device 104 are not physical devices.

The plurality of primary logical storage devices (102a, 102b) are planned into a plurality of data blocks in a first RAID architecture 106a. On the viewpoint of fault tolerance, the plurality of data blocks can be classified into two kinds of data blocks which are the user data blocks and the parity data blocks. The user data blocks store general user data. The parity data blocks store a set of remaining parity data to provide to inversely calculate the user data when the fault tolerant is required. In the same block group, data in the parity data block are a result of Exclusive OR (XOR) operation executed on the data in the user data blocks. It is noticed that those of ordinary skill in the art all understand the calculation of the data in the parity data blocks can also be executed by, other than Exclusive or (XOR) operation, various parity operations or similar operations which just have the relationship that data of any data block can be obtained by calculating data of corresponding data blocks in the same block group.

The at least one spare logical storage device 104 is planned into a plurality of spare blocks in a second RAID architecture 106b. Each data block and each spare block are considered as a chunk, and are assigned a unique chunk identifier (Chunk_ID) in sequence. A chunk size (Chunk_Size) of each chunk is defined.

The plurality of physical storage devices (12a˜12n) are grouped into at least one storage pool (16a, 16b). Each physical storage device (12a˜12n) is assigned a unique physical storage device identifier (PD_ID), and planned into a plurality of first blocks. The size of each first block is equal to the Chunk_Size. A respective physical storage device count (PD_Count) of each storage pool (16a, 16b) is defined. It is noted that different from the prior arts, the plurality of physical storage devices (12a˜12n) are not planned into an RAID.

In practical application, each of the physical storage devices (12a˜12n) can be a tape drive, a disk drive, a memory device, an optical storage drive, a sector corresponding to a single read-write head in the same disk drive, or other equivalent storage device.

Also as shown in FIG. 1, FIG. 1 also illustratively shows an application I/O request unit 2. The application I/O request unit 2 is coupled to the data storage system 1 of the invention through a transmission interface 11. In practical application, the application I/O request unit 2 can be a network computer, a mini-computer, a mainframe, a notebook computer, or any electronic equipment need to read or write data in the data storage system 1 of the invention, e.g., a cell phone, a personal digital assistant (PDA), a digital recording apparatus, a digital music player, and so on.

When the application I/O request unit 2 is a stand-alone electronic equipment, it can be coupled to the data storage system 1 of the invention through a transmission interface such as a storage area network (SAN), a local area network (LAN), a serial ATA (SATA) interface, a fiber channel (FC), a small computer system interface (SCSI), and so on, or other I/O interfaces such as a PCI express interface. In addition, when the application I/O request unit 2 is a specific integrated circuit device or other equivalent devices capable of transmitting I/O read or write requests, it can send read or write requests to the disk array processing module 10 in accordance with commands (or requests) from other devices, and then read or write data in the physical storage devices (12a˜12n) via the disk array processing module 10.

The virtual block processing module 14 is respectively coupled to the disk array processing module 10 and the plurality of physical storage devices (12a˜12n). The virtual block processing module 14 functions in building a plurality of virtual storage devices (142a˜142n). Each virtual storage device (142a˜142n) is assigned a unique virtual storage device identifier (VD_ID), and planned into a plurality of second blocks. The size of each second block is equal to the Chunk_Size. A virtual storage device count (VD_Count) of the plurality of virtual storage devices (142a˜142n) is defined.

The virtual block processing module 14 calculates one of the Chunk_IDs mapping each second block in accordance with the Chunk_Size, the VD_Count, the VD_ID and a virtual storage device logical block address (VD_LBA) in the virtual storage devices, and calculates the PD_ID of one of the first blocks and a physical storage device logical block address (PD_LBA) in the physical storage devices mapping said one Chunk_ID. The disk array processing module 10 accesses data in accordance with the PD_ID and the PD_LBA of each Chunk_ID.

In one embodiment, the calculation of one of the Chunk_IDs mapping each second block is executed by a first one-to-one and onto function.

In one embodiment, the calculation of one of the Chunk_IDs mapping each second block is executed by the following function:

Chunk_ID=(((VD_ID+VD_Rotation_Factor) % VD_Count)+((VD_LBA/Chunk_Size)×VD_Count)), where % is a modulus operator, VD_Rotation_Factor is an integer.

In one embodiment, the calculation of the PD_ID of one of the first blocks mapping said one Chunk_ID is executed by a second one-to-one and onto function. The calculation of the PD_LBA in the physical storage devices (12a˜12n) mapping said one Chunk_ID is executed by a third one-to-one and onto function.

In one embodiment, the calculation of the PD_ID of one of the first blocks mapping said one Chunk_ID is executed by the following function:

PD_ID=(((Chunk_ID % PD_Count)+PD_Rotation Factor) % PD_Count), where % is a modulus operator, PD_Rotation_Factor is an integer;
In one embodiment, the calculation of the PD_LBA in the physical storage devices (12a˜12n) mapping said one Chunk_ID is executed by the following function:

PD LBA=(((Chunk_ID/PD_Count)×Chunk_Size)+(VD_LBA Chunk_Size)).

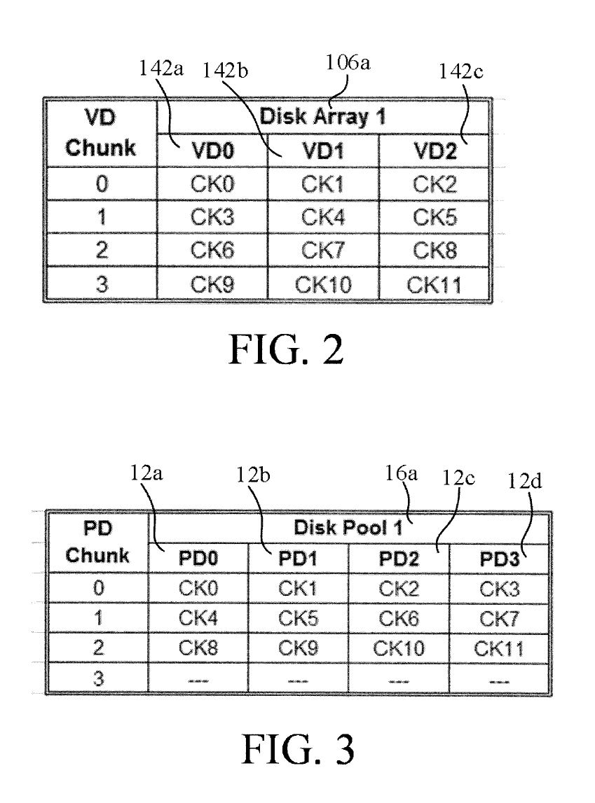

Referring to FIG. 2, an example of a mapping relationship between a plurality of data blocks (CK0˜CK11) of the first RAID architecture 160a and a plurality of second blocks of the plurality of virtual storage devices (142a˜142c) is illustratively shown in FIG. 2. It is noted that the example as shown in FIG. 2 exists in the data storage system 1 of the invention by direct calculation rather than a mapping table occupying memory space.

Referring to FIG. 3, an example of a mapping relationship between a plurality of data blocks (CK0˜CK11) of the first RAID architecture 106a and a plurality of first blocks of the plurality of physical storage devices (12a˜12d) of a storage pool 16a is illustratively shown in FIG. 3. It is noted that the example as shown in FIG. 3 exists in the data storage system 1 of the invention by direct calculation rather than a mapping table occupying memory space.

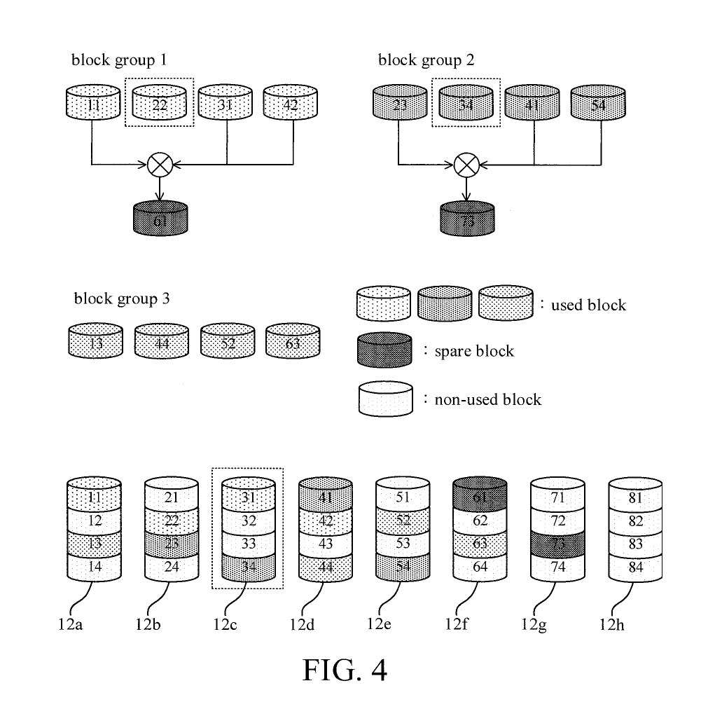

Referring to FIG. 4, an example of mapping the user data blocks, the parity data blocks and the spare blocks in the same block group to the plurality of first blocks of the plurality of physical storage devices (12a˜12h) is illustratively shown in FIG. 4. In FIG. 4, the physical storage device 12c is damaged, the procedures of reconstructing the data in the physical storage device 12c are also schematically illustrated. Because the procedures of reconstructing the data in the physical storage device 12c are performed by dispersedly rewriting data into the first blocks of the plurality of physical storage devices (12a˜12h) mapping the spare blocks, the data storage system 1 of the invention has no the bottleneck of the prior arts where data are rewritten into the at least one spare physical storage device during the reconstruction of the damaged physical storage device.

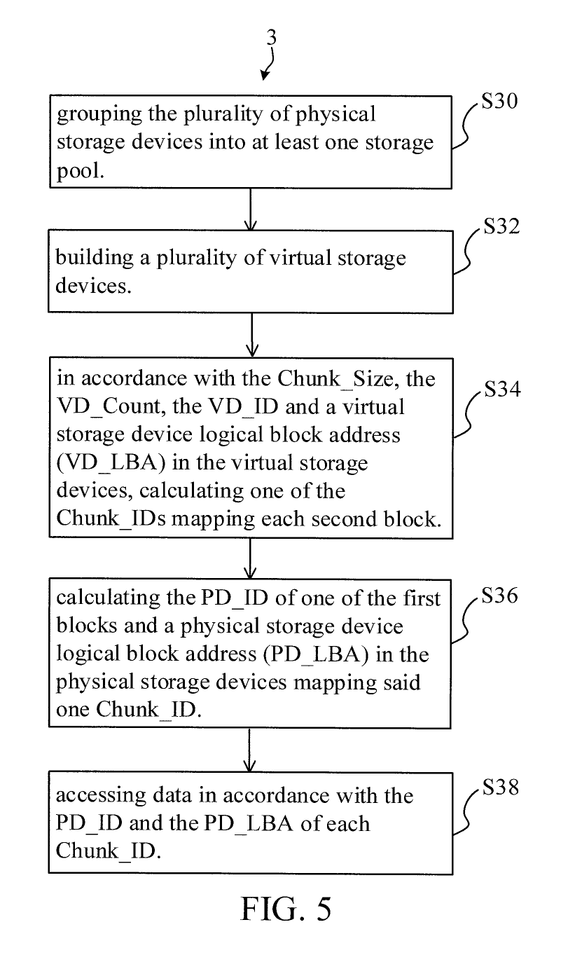

Referring to FIG. 5, FIG. 5 is a flow diagram illustrating a managing method 3 according to a preferred embodiment of the invention. The managing method 3 according to the invention is performed for a data storage system, e.g., the data storage system 1 shown in FIG. 1. The architecture of the data storage system 1 has been described in detail hereinbefore, and the related description will not be mentioned again here.

As shown in FIG. 5, the managing method 3 of the invention, firstly, performs step S30 to group the plurality of physical storage devices (12a˜12n) into at least one storage pool (16a, 16b) where a respective physical storage device count (PD_Count) of each storage pool (16a, 16b) is defined.

Next, the managing method 3 of the invention performs step S32 to build a plurality of virtual storage devices (12a˜12n). Each virtual storage device (12a˜12n) is assigned a unique virtual storage device identifier (VD_ID), and planned into a plurality of second blocks. The size of each second block is equal to the Chunk_Size. A virtual storage device count (VD_Count) of the plurality of virtual storage devices (142a˜142n) is defined.

Afterward, the managing method 3 of the invention performs step S34 to calculate one of the Chunk_IDs mapping each second block in accordance with the Chunk_Size, the VD_Count, the VD_ID and a virtual storage device logical block address (VD _LBA) in the virtual storage devices (142a˜142n).

Then, the managing method 3 of the invention performs step S36 to calculate the PD _ID of one of the first blocks and a physical storage device logical block address (PD_LBA) in the physical storage devices (12a˜12n) mapping said one Chunk_ID.

Finally, the managing method 3 of the invention performs step S38 to access data in accordance with the PD_ID and the PD_LBA of each Chunk_ID.

It noted that compared to the prior arts, the data storage system and the managing method thereof according to the invention have no spare physical storage device, and that the procedures of reconstructing the data in the physical storage device are performed by dispersedly rewriting data into the first blocks of the plurality of physical storage devices mapping the spare blocks; and therefore, the data storage system and the managing method according to the invention have no the bottleneck of the prior arts where data are rewritten into the at least one spare physical storage device during the reconstruction of the damaged physical storage device. The data storage system and the managing method according to the invention have virtual blocks and RAID architectures, and can significantly reduce time spent in reconstructing failed or replaced physical storage devices in the data storage system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data storage system, comprising:
a disk array processing module, for accessing or rebuilding data on the basis of a plurality of primary logical storage devices and at least one spare logical storage device, wherein the plurality of primary logical storage devices are planned into a plurality of data blocks in a first RAID architecture, the at least one spare logical storage device is planned into a plurality of spare blocks in a second RAID architecture, each data block and each spare block are considered as a chunk and are assigned a unique chunk identifier (Chunk_ID) in sequence, and a chunk size (Chunk_Size) of each chunk is defined;
a plurality of physical storage devices, being grouped into at least one storage pool, wherein each physical storage device is assigned a unique physical storage device identifier (PD_ID) and planned into a plurality of first blocks, the size of each first block is equal to the Chunk_Size, a respective physical storage device count (PD_Count) of each storage pool is defined; and
a virtual block processing module, respectively coupled to the disk array processing module and the plurality of physical storage devices, for building a plurality of virtual storage devices which each is assigned a unique virtual storage device identifier (VD_ID) and planned into a plurality of second blocks, wherein the size of each second block is equal to the Chunk_Size, a virtual storage device count (VD_Count) of the plurality of virtual storage devices is defined;
wherein the virtual block processing module calculates one of the Chunk_IDs mapping each second block in accordance with the Chunk_Size, the VD_Count, the VD_ID and a virtual storage device logical block address (VD_LBA) in the virtual storage devices, and calculates the PD_ID of one of the first blocks and a physical storage device logical block address (PD_LBA) in the physical storage devices mapping said one Chunk_ID, the disk array processing module accesses data in accordance with the PD_ID and the PD_LBA of each Chunk_ID.

2. The data storage system of claim 1, wherein the calculation of one of the Chunk_IDs mapping each second block is executed by a first one-to-one and onto function.

3. The data storage system of claim 1, wherein the calculation of one of the Chunk_IDs mapping each second block is executed by the following function:
Chunk_ID=(((VD_ID+VD_Rotation_Factor) % VD_Count)+((VD_LBA/Chunk_Size)×VD_Count)),
where % is a modulus operator, VD_Rotation_Factor is an integer.

4. The data storage system of claim 1, wherein the calculation of the PD_ID of one of the first blocks mapping said one Chunk_ID is executed by a second one-to-one and onto function, the calculation of the PD_LBA in the physical storage devices mapping said one Chunk_ID is executed by a third one-to-one and onto function.

5. The data storage system of claim 4, wherein the calculation of the PD_ID of one of the first blocks mapping said one Chunk_ID is executed by the following function:
PD_ID=(((Chunk_ID % PD_Count)+PD_Rotation_Factor) % PD_Count),
where % is a modulus operator, PD_Rotation_Factor is an integer;
the calculation of the PD_LBA in the physical storage devices mapping said one Chunk_ID is executed by the following function:
PD_LBA=(((Chunk_ID/PD_Count)×Chunk_Size)+(VD_LBA % Chunk_Size)).

6. A management method for a data storage system which accesses or rebuilds data on the basis of a plurality of primary logical storage devices and at least one spare logical storage device, wherein the plurality of primary logical storage devices are planned into a plurality of data blocks in a first RAID architecture, the at least one spare logical storage device is planned into a plurality of spare blocks in a second RAID architecture, each data block and each spare block are considered as a chunk and are assigned a unique chunk identifier (Chunk_ID) in sequence, and a chunk size (Chunk_Size) of the chunk is defined, the data storage system comprises a plurality of physical storage devices, each physical storage device is assigned a unique physical storage device identifier (PD_ID) and planned into a plurality of first blocks, the size of each first block is equal to the Chunk_Size, said management method comprising the steps of:
grouping the plurality of physical storage devices into at least one storage pool, wherein a respective physical storage device count (PD_Count) of each storage pool is defined;
building a plurality of virtual storage devices, wherein each virtual storage device is assigned a unique virtual storage device identifier (VD_ID) and planned into a plurality of second blocks, the size of each second block is equal to the Chunk_Size, a virtual storage device count (VD_Count) of the plurality of virtual storage devices is defined;
in accordance with the Chunk_Size, the VD_Count, the VD_ID and a virtual storage device logical block address (VD_LBA) in the virtual storage devices, calculating one of the Chunk_IDs mapping each second block;
calculating the PD_ID of one of the first blocks and a physical storage device logical block address (PD_LBA) in the physical storage devices mapping said one Chunk_ID; and
accessing data in accordance with the PD_ID and the PD_LBA of each Chunk_ID.

7. The management method of claim 6, wherein the calculation of one of the Chunk_IDs mapping each second block is executed by a first one-to-one and onto function.

8. The management method of claim 6, wherein the calculation of one of the Chunk_IDs mapping each second block is executed by the following function:
Chunk_ID=(((VD_ID+VD_Rotation_Factor) % VD_Count)+((VD_LBA/Chunk_Size)×VD_Count)),
where % is a modulus operator, VD_Rotation_Factor is an integer.

9. The management method of claim 6, wherein the calculation of the PD_ID of one of the first blocks mapping said one Chunk_ID is executed by a second one-to-one and onto function, the calculation of the PD_LBA in the physical storage devices mapping said one Chunk_ID is executed by a third one-to-one and onto function.

10. The management method of claim 9, wherein the calculation of the PD_ID of one of the first blocks mapping said one Chunk_ID is executed by the following function:
PD_ID=R(Chunk_ID % PD_Count)+PD_Rotation_Factor) % PD_Count),
where % is a modulus operator, PD_Rotation_Factor is an integer;
the calculation of the PD_LBA in the physical storage devices mapping said one Chunk_ID is executed by the following function:
PD_LBA=(((Chunk_ID/PD_Count)×Chunk_Size)+(VD_LBA % Chunk_Size)).
